(19) United States
(12) Patent Application Publication
(10) Pub. No.: US 2006/0132945 A1
(43) Pub. Date: Jun. 22, 2006

(54) Microstructured optical film and production process thereof

(76) Inventor: Koichi Sano, Sagamihara-city (JP)

Correspondence Address: 3M INNOVATIVE PROPERTIES COMPANY, PO BOX 33427, ST. PAUL, MN, 55133-3427, US

(21) Appl. No.: 10/559,521

(22) PCT Filed: Apr. 20, 2004
(86) PCT No.: PCT/US04/12267

§ 371 Date: Dec. 2, 2005

(30) Foreign Application Priority Data
Jun. 6, 2003 (JP) 2003-162477

(51) Int. Cl. G02B 5/08; G02B 7/182

(52) U.S. Cl. 359/883

(57) ABSTRACT

To provide an optical film (10) which is improved in visibility without the adhesive of a fingerprint and the deterioration of the contrast, is capable of resisting of scratch or the like, and is useful particularly for a touch panel or an image display device. The optical film (10) comprises a transparent reflection film (2) on the surface of which a plurality of surface reflection distribution areas (A) each containing at least one microstructure are provided.

### FIELD OF THE INVENTION

The present invention relates to an optical film, and in particular to an optical film having high viewability when adhered on an input/output device such as a touch panel or graphic panel. The present invention also relates to a method of manufacturing such a high performance optical film easily with high accuracy. The present invention also relates to an image display device comprising such an optical film provided on the image display surface thereof.

### BACKGROUND

Known electronic displays include liquid crystal displays (LCD), EL (electroluminescent) displays, plasma displays, and the like, and can be used for large-sized or small-sized image display devices. Many applications utilize input/output devices such as a touch panels or graphic panels with electronic displays. For example, touch panels are widely used for ATMs (Automated Teller Machines) of banks, since recent liquid crystal display panels have been improved in visibility. When using an ATM, a bank customer can directly touch the touch panel with a his/her finger to perform input operation in question and answer form. Touch panels are also widely used for PDAs (personal data assistants). PDAs include, for example, those sold under the trade names “Zaurus” of Sharp Corp., “Newton” of Apple Computer Inc., “Cassiopeia” of Casio Computer Co., Ltd., and “Visor” of Handspring. When using a PDA, a user can perform input operation easily by touching the touch panel with a stylus pen. Furthermore, graphic panels are used to indicate equipment, instruments, and the like in industrial settings. An operator or user of a factory can monitor the equipment, instruments, and the like displayed on a graphic panel and control the factory by directly touching the display surface of the graphic panel with a his/her finger or a stylus pen.

As described above, the performance of a touch panel, graphic panel, or other input/output device heavily depends on the visibility of the liquid crystal display panel. However, there is a problem that the visibility of the liquid crystal display panel is unable to be maintained with stability for the long term as a result of performing input/output operation by directly touching the image display surface (hereinafter called “touch input/output surface”, “touch input surface”, or “touch surface”) of the input/output device with a finger or pen. As a result of performing various operations repeatedly by touching the touch input/output surface with a user's finger or a pen, the transparency of the whole of the touch input/output surface is reduced due to the reflection of light on the touch input/output surface, and thereby the visibility of the touch input/output surface is reduced. Furthermore, when the reflection of light as described above exists, the periphery of the touch input/output surface may be reflected into the touch input/output surface, and thereby the visibility is reduced.

Conventionally, in order to prevent the reduction of the visibility of the touch input/output surface, touch input/output surfaces have been provided with a pattern of bumps or dips. For example, a transparent film substrate manufacturing method has been proposed to manufacture a transparent film substrate provided on the touch side of a touch panel, and in which the touch input surface side of the substrate is roughened to a centerline average roughness of 0.05 to 0.8 μm, and the roughened surface is coated with transparent metallic compound or synthetic resin (Japanese Unexamined Patent Publication (Kokai) No. 10-172377).

Furthermore, a molded object such as lens has been proposed which does not target the improvement of the visibility of a touch panel, but prevents eyestrain by reducing the reflection of light, and is excellent in the sense of wearing (Japanese Unexamined Patent Publication (Kokai) No. 5-123378). On the surface of this molded object, a transparent coating layer is formed which includes a fine particle-like inorganic substance consisting of one or more kinds of particular metallic oxides, and a silicon high-molecular compound consisting of one or more kinds of particular organosilicon compounds.

### SUMMARY OF THE INVENTION

One aspect of the present invention is an optical film comprising a transparent reflecting film on the surface of which a plurality of surface reflection distribution areas each containing at least one microstructure are provided.

The transparent reflecting film may be used alone, that is, without a substrate supporting it, or may be supported by a substrate. In the latter case, the optical film preferably comprises a transparent sheet-like substrate and a transparent reflecting film (also called “reflecting layer” in this specification) formed on one side of the substrate.

Another aspect of the present invention is an optical film manufacturing method comprising a step of making a reflecting film by adding a plurality of surface reflection distribution areas each containing at least one microstructure to one side of a transparent film by transfer.

In this optical film manufacturing method, the reflecting film may be made in the form of a self-sustained film without a substrate, or in the form of a transparent reflecting layer supported by a transparent sheet-like substrate.

Furthermore, the transfer of the surface reflection distribution areas may be performed by using an embossing technique, or by charging curable or settable molding material in a mold and hardening the curable or settable molding material.

Another aspect of the present invention is an image display device comprising an optical film according to the present invention provided on the image display surface of the image display panel thereof.

### BRIEF DESCRIPTION OF THE DRAWINGS

FIG. 1 is a plan view showing a preferred embodiment of an optical film according to the present invention.

FIG. 2 is a cross-sectional view of the optical film shown in FIG. 1 taken along line II-II.

FIG. 3 is a cross-sectional view showing another preferred embodiment of an optical film according to the present invention.

FIG. 4 is a cross-sectional view showing another preferred embodiment of an optical film according to the present invention.

FIG. 5 is a cross-sectional view showing another preferred embodiment of an optical film according to the present invention.

FIG. 6 is a partially enlarged view of the optical film shown in FIG. 5.

FIG. 7 is a perspective view of a PDA on which an optical film according to the present invention is adhered.

FIG. 8 is a cross-sectional view of the PDA shown in FIG. 7 taken along line VIII-VIII.

FIG. 9 is a cross-sectional view showing, in sequence, a preferred method of manufacturing an optical film according to the present invention.

FIG. 10 is a schematic view showing another preferred method of manufacturing an optical film according to the present invention.

### DETAILED DESCRIPTION

As described in the Background, although the reflection of light on the touch surface and the reflection of the periphery into the touch surface may be reduced using prior approaches, there still have been some problems caused by bumps and dips on the touch surface of a touch panel. For example, since a pattern of bumps and dips is formed at random on the touch surface, light reflected on the touch surface diffuses and the contrast of the touch surface deteriorates, which reduces the visibility of the touch surface. Furthermore, in case of a touch panel the touch surface of which a user touches with his/her finger, the a mark such as a fingerprint also deteriorates the visibility of the surface.

Furthermore, in case of a touch panel that a user touches with a stylus, the quality of writing becomes a problem. When the touch surface is smooth, the stylus slides on the surface. When bumps and dips are formed at random on the touch surface as described above, the stylus movement can be adversely affected, resulting in poor performance and incorrect inputs. In addition, it may be possible that the touch surface is scratched with a stylus.

The invention is aimed at solving the technical problems identified above.

That is, it is an object of the present invention to provide an optical film which is improved in visibility, that resists fingerprinting that can deteriorate display contrast, and is capable of resisting scratches. In particular, the present invention provides an optical film that can be adhered to an input/output device such as a touch panel or graphic panel, the optical film providing the input/output surface.

It is another object of the present invention to provide a method of manufacturing an optical film according to the present invention easily with high accuracy.

It is another object of the present invention to provide an image display device capable of taking advantages of the aforementioned features of an optical film according to the present invention.

The aforementioned objects and other objects of the present invention will be easily appreciated from the following detailed descriptions.

As described above, the present invention resides in an optical film, an optical film manufacturing method, and an image display device comprising an optical film according to the present invention adhered on the image display surface thereof. Preferred embodiments of the present invention are described below with reference to the accompanying drawings. However, the present invention is not limited to particular embodiments described below.

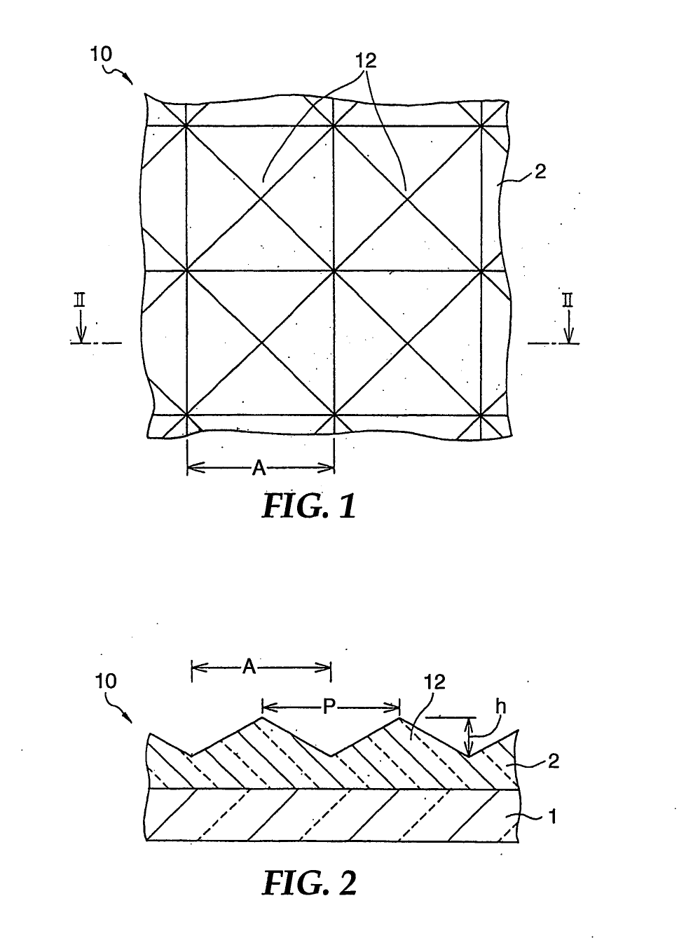

An optical film according to the present invention may be provided in the form of a self-sustained film or a film supported by a substrate. FIGS. 1 and 2 show an example of an optical film supported by a substrate. As easily understood from FIG. 2, which is a cross-sectional view of the optical film 10 shown in FIG. 1 taken along line II-II, the optical film 10 comprises at least a transparent sheet-like substrate 1 and a transparent reflecting layer 2 formed on the substrate 1. Furthermore, the optical film 10 includes a plurality of surface reflection distribution areas A on the surface of the reflecting layer 2, and in each of the areas, a microstructure 12 is formed (for example, a prismatic microstructure shaped like a quadrangular pyramid). Two or more microstructures 12 may be formed in each of the surface reflection distribution areas A if required, which is not shown in the figures. It is preferable that the microstructures 12 on the reflecting layer 2 are disposed in a regular pattern, have a predetermined shape and height, and are distributed with a predetermined density.

In the optical film of the present invention, surface reflection distribution areas are provided on the reflecting layer formed on the transparent sheet-like substrate by disposing the transparent microstructures (preferably prismatic microstructures) which are controlled in shape, height, and distribution density, and thereby light incident on the surface of the optical film can be reflected in various directions by the surfaces of the microstructures, and strong mirror reflection to a particular direction from the plane surface can be prevented. As a result, even if a strain such as a fingerprint adheres to the surface of the optical film, the strain is not very conspicuous, and thereby deterioration of the display performance is suppressed and the visibility is improved.

The “microstructure” referred in this specification means a surface pattern which is very minute, and the existence of which is unable to be substantially detected with the naked eye. That is, the microstructure is a microscopic minute structure incapable of being clearly distinguished when it is observed visually from any of the surfaces of it. The term “microscopic” refers to features of small enough dimension so as to require an optic aid to the naked eye when viewed from any plane of view to determine its shape. One criteria is found in Modern Optic Engineering by W. J. Smith, McGraw-Hill, 1966, pages 104-105 whereby visual acuity is “defined and measured in terms of the angular size of the smallest character that can be recognized.” Normal visual acuity is considered to be when the smallest recognizable character subtends an angular height of 5 minutes of arc on the retina At typical working distance of 250 mm (10 inches), this yields a lateral dimension of 0.36 mm (0.0145 inches) for this object.

In the optical film of the present invention, the transparent sheet-like substrate may be made of various materials in different thicknesses. Typically, the sheet-like substrate preferably at least has thickness that does not affect the visibility, durability, etc., and flexibility enough to the adhering work, in consideration of being used for an image display device being adhered on the image display surface of it. Furthermore, in case that this optical film is intended to be used for an input/output device such as a touch panel being adhered on it, it is required to have hardness and durability enough to withstand the pressure applied by a finger or pen, and flexibility enough to transfer the pressure precisely to the input/output device.

Preferred sheet-like substrates in the practice of the present invention include but are not limited to plastic films made of polyethylene terephthalate (PET), polyethylene naphtalate (PEN), oriented polypropylene, polycarbonate, triacetate, or the like. In particular, a PET film is useful as a substrate. For example, a polyester film such as a Tetron™ film, MELINEX™ film (available from DuPont Teijin), or the like may be used as a substrate. These plastic films are normally used as a single layer film, but two or more kinds of these films may be combined, if required, to be used as a composite film or laminated film.

Furthermore, a sheet-like substrate may be used in various thickness according to the layer construction, the particular application, or the like of an optical film, and is generally used in the thickness of about 10 μm to about 500 ρm, and preferably about 50 μm to about 300 μm.

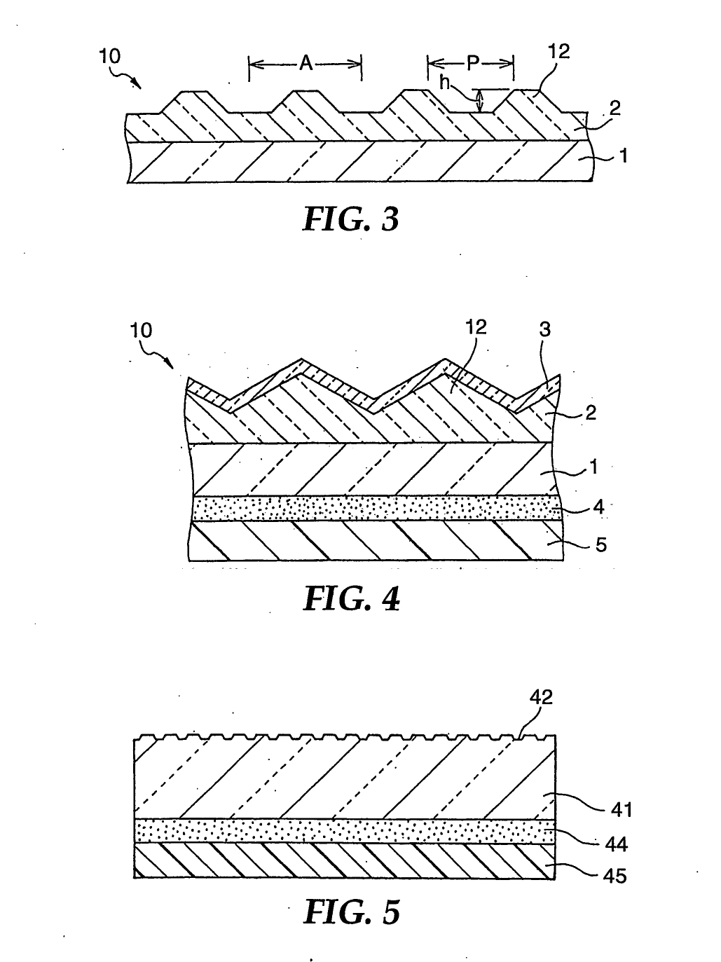

In the optical film of the present invention, the microstructures of its reflecting layer may be made in various forms within the scope of the objects and effect of the present invention, and are preferably prismatic microstructures, because the prismatic microstructures are able to disperse light in a plurality of directions to prevent glare. Non-limiting examples of a prismatic microstructures includes those shaped like a quadrangular pyramid as shown in FIGS. 1 and 2, a triangular pyramid, a truncated pyramid, or the like. For example, FIG. 3 shows an example of an optical film 10, wherein a reflecting layer 2 is formed on a sheet-like substrate 1, and one prismatic microstructure shaped like a quadrangular truncated pyramid is formed in each of the surface reflection distribution areas A of the reflecting layer 2. The microstructures may be integrated, if desired, with the underlain sheet-like substrate by omitting the reflecting layer 2, or a reflecting layer may be constructed as a reflecting film by omitting a sheet-like substrate, which results an optical film without a substrate (self-sustained optical film).

The microstructures may be formed in various sizes. For example, when a surface reflection distribution area in which a microstructure is disposed is assumed to be a rectangle when viewed from on high, the length of one side of the rectangle is normally about 10 μm to about 500 μm, and preferably about 50 μm to about 300 μm. The height of a microstructure is normally about 10 μm to about 500 μm, and preferably about 50 μm to about 300 μm, although it is slightly variable according to whether the microstructure is truncated or not.

The material of the reflecting layer on which microstructures such as prismatic microstructures are provided is not limited, subject to the preference for visible light transparency. Glass, various plastic materials, or the like can be used to form the reflecting layer, and plastic materials are used advantageously from the viewpoint of workability.

As with the sheet-like substrate described above, the reflecting layer may be made of various plastic materials and in different thicknesses according to the layer construction of the optical film, its intended use, or the like. Suitable plastic materials include but are not limited to acrylic resin, polycarbonate resin, polyester resin, urethane resin, epoxy resin, polystyrene resin, and the like, and mixtures of these resins. An exemplary plastic material may be selected as appropriate in consideration of optical characteristics such as viscosity (effective on handleability), refractive index, and the like of these resins. A PET or the like is suitable as a reflecting layer material.

When the microstructures are very fine and not easily formed, it is recommended that the microstructures are formed by a transcription method or the like as described below. In such a case, the reflecting layer is preferably formed from a hardened article of curable or settable resin material. That is, the reflecting layer may be a film made in a manner that the curable or settable resin material is formed like a film and then hardened by applying heat, light, or other energy to it. The curable or settable resin material is thus preferably a heat-curable resin material or a photo-curable resin material, or a thermoplastic resin material. In particular, photo-curable (e.g., UV-curable) resin materials do not require a long and large furnace for forming a reflecting layer and are able to be cured in a relatively short time, thus being useful. Photo-curable resin materials preferably include photo-curable monomers and oligomers, and further preferably include (meta) acrylate monomers and oligomers, that is, acrylate or methacrylate monomers and oligomers.

In more detail, acrylate monomers suitable for forming the reflecting layer include but are not limited to urethanacrylate, polyesteracrylate, polyetheracrylate, acrylamide, acrylonitrile, acrylic acid, acrylic acid ester, etc. Acrylate oligomers suitable for forming the reflecting layer include but are not limited to urethanacrylate oligomers, epoxyacrylate oligomers, etc. In particular, urethanacrylate and its oligomers can be cured to be flexible and stiff articles at extremely higher speed than that of all other acrylate, thereby contributing to the improvement of productivity of optical films. In addition, when such an acrylate monomer or oligomer is used, an optically transparent reflecting layer can be obtained. These acrylate monomers and oligomers may be used alone or in optional combinations of two or more kinds of them. Particularly described above are features, etc. of acrylate monomers and oligomers, although methacrylate monomers and oligomers also have similar features, etc.

Curable or settable resin materials may contain optional additives. For example, in cases where the curable resin materials are photo-curable resin materials, photo-polymerization initiators are suitable additives for them. For example, compounds can be selected as suitable photo-polymerization initiators in accordance with the kinds of curable resin materials. Exemplary compounds include phenoxyethyl acrylate, 2-hydroxy-2-methyl-1-phenyl-propane-1-on, bis(2,4,6-trimethylbenzoyl)-phenylphosphine-oxide, etc. These photo-polymerization initiators may be used alone or in combination of two or more kinds of them.

The reflecting layer may be used in various thicknesses on the sheet-like substrate according to the layer construction of the optical film, its intended use, or the like. The thickness of the reflecting layer is normally about 5 μm to about 1000 μm, and preferably about 10 μm to about 100 μm.

The optical film may further comprise optional elements in addition to the sheet-like substrate and reflecting layer.

FIG. 4 is a cross-sectional view of another optical film according to the present invention obtained by providing an additional layer on the optical film described before with reference to FIG. 2. The optical film 10 shown in FIG. 4 further comprises a transparent thin protective coating 3 formed on the reflecting layer 2 formed on one side of the sheet-like substrate 1. The protective coating 3 may be formed as a hard coat layer if desired. On the back of the sheet-like substrate 1, a release liner 5 is adhered through an adhesive layer 4. The optical film 10 can be easily adhered to a touch panel or the like by peeling off the release liner 5.

When the protective coating is formed as the top layer of the optical film in the form of a thin coating, it gives to the optical film a stain resistance, good durability, and good strength. The protective coating may be made of various materials by an optional coating making method, and preferably made of a low adhesion compound from the viewpoint of preventing the adhesion of dust or the like. Low adhesion compounds suitable for making the protective coating include but are not limited to fluorine-containing compounds, silicon-containing compounds, etc. In particular, fluorine-containing compounds are suitable, because they are excellent in transparency and adherence to the underlying reflecting layer and can be formed in thin coating without damaging the microstructures on the surface of the reflecting layer. Fluorine-containing compounds suitable for making the protective coating include compounds containing a perfluoro polyether group and an alkoxy silane group in the molecules. Such fluorine-containing compounds are commercially available as fluorine silane coupling agents including for example a fluorine silane coupling agent which is given by the following formula:

Solids: (20 wt % in product)
F—(CF₂CF₂CF₂O)ₙ—Si(OMe)₃: 80 mol %
F—(CF₂CF₂CF₂O)ₙ—CF₂CF₃: 20 mol %
Me=methyl group

Solvent: (80 wt % in product)
(CF₃)₂—CFCF₂CF₂CF₃(Perfluoroisohexane)

This coupling agent is commercially available under the trade name “Optool DSX” from Daikin.

The protective coating may be formed in various thicknesses, and is preferably as thin as possible in consideration of the reappear of the microstructures, etc. The thickness of the protective coating is normally about 0.1 to about 200 nm, preferably about 0.5 to about 100 nm.

When the optical film 10 comprises an adhesive layer 4 as described with reference to FIG. 4, the adhesive layer 4 is preferably covered with a release liner in consideration of its handleability, etc. As the release liner and an adhesive layer for connecting the release liner to the sheet-like substrate, regular ones may be respectively used in optional thickness.

Generally speaking, the release liner may be constructed advantageously from various base materials. Base materials suitable for making the release liner include paper, plastic materials such as polyethylene, polypropylene, polyester, cellulose acetate, polyvinyl chloride, and polyvinylidene fluoride, and paper and other materials covered with such a plastic material or on which such a plastic material is adhered. The release liner may be used as it is, and preferably used after it is treated by a silicone treatment method or other method to improve the peel characteristic of it. The thickness of the release liner is normally but not limited to about 25 μm to about 200 μm.

Furthermore, the adhesive layer may be made of various adhesives such as pressure-sensitive adhesives (PSA). Pressure-sensitive adhesives useful for making the adhesive layer include but are not limited to acrylic adhesives, tackifier rubber, tackifier synthetic rubber, ethylene-vinyl acetate, silicone, etc.

Such an adhesive may be a polymer coated on the release liner after being dispersed into solvent or water and then dried, or further cross-linked optionally. When a solvent or water bone pressure-sensitive adhesive composition is used, a drying process for removing all or much of solvent or water is required for making the adhesive layer. The adhesive may be a hot-melt adhesive. In addition, an adhesive composition having low molecular weight may be coated on the release liner and then polymerized by the radiation of energy such as heat, UV, or electron beam.

The thickness of the adhesive layer may be changed in wide range in accordance with many factors including, for example, the composition of the adhesive, the construction of the optical film, and the thickness of the release liner. In general, the thickness of the adhesive layer is about 10 μm to about 50 μm.

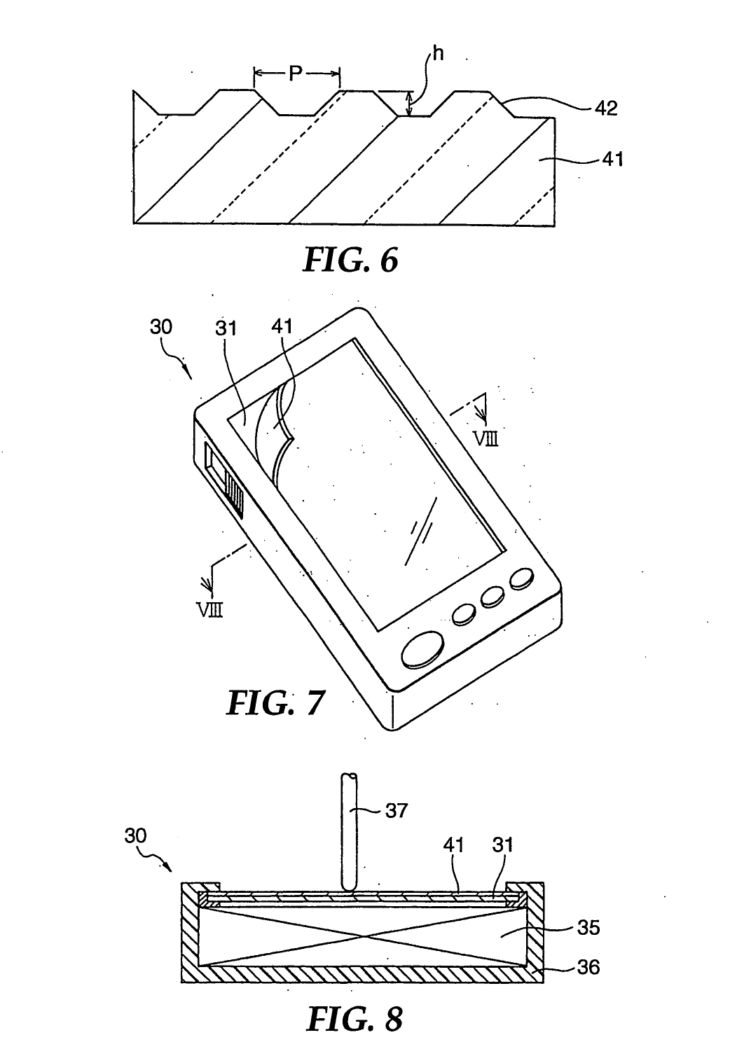

FIG. 5 shows an example of a self-sustained optical film without a substrate as a support. The optical film 41 is one modification of the above-described optical film comprising a support having applied thereon a reflecting layer, and has many microstructures 42 (fine prismatic microstructures shaped like a quadrangular truncated pyramid) on the surface thereof as shown in FIG. 6, which is enlarged view of it. The optical film 41 may be made of plastic material, in optional thickness, similar to that of the aforementioned sheet-like substrate and reflecting layer. The thickness of the optical film 41 is normally about 10 μm to about 1000 μm. The pitch (p) of the microstructures 42 is normally variable between about 160 μm and about 254 μm, and the height of them is normally variable between about 10 μm to 15 μm.

Furthermore, the optical film 41 shown in FIG. 5 has an adhesive layer 44 and release liner 45 on a back surface thereof. The adhesive layer 44 and release liner 45 may be respectively made of the same materials in the same thickness as ones of the adhesive layer 4 and release liner 5 of the optical film 10 described with reference to FIG. 4.

More specifically, the optical film 41 may include an optically transparent PET film having the thickness of 50 μm and is provided with the adhesive layer 44 having the thickness of 25 μm made of an acrylic adhesive and a polyester (PET) release liner 45 having the thickness of 35.5 μm covered with a silicon release agent (not shown). The PET film is a MELINEX™ film. The optical film 41 is profiled with a plurality of quadrangular truncated pyramid microstructures 42 formed, as described above, in a pattern with a pitch variable between 160 and 254 μm and a depth variable between 10 and 15 μm.

The microstructure 42 may be formed easily in a manner that a PET film is disposed on a heated steel roll (mold) and embossed by using a flame embossing technique. The height of the quadrangular truncated pyramid microstructures would decrease with increasing the density of them (with decreasing the pitch of them).

Optical characteristics measured on the optical film 41 were the transmittance, haze value, and transparency. The haze value of the optical film increased with increasing the density of the pattern, but no substantial change was noted for the transmittance and transparency.

The optical film according to the present invention may be used for various image display devices normally being adhered on the image display surface of each of the image display devices in a manner that the reflecting layer side of the optical film is exposed. Suitable image display devices include but are not limited to LCD devices, EL display devices, plasma display devices, etc. If desired, the optical film may be adhered to an article or device other than image display devices. The optical film may be suitably used as, for example, displaying means including graphics films, photograph plates, signboards, etc.

The optical film of the present invention may be, in particular, advantageously used in combination with an image display device having an input/output device such as a touch panel or graphic panel in a manner that it is adhered on the touch surface of the input/output device, because even if an input operation is performed by touching the reflecting layer of the optical film with a pen or finger, various characteristics peculiar to the optical film are not deteriorated and the damage, contamination, etc. of the optical film can be substantially reduced or avoided. Image display devices equipped with an input/output device include but are not limited to touch panel-type car navigation systems, automated teller machines (ATMs) of banks, and personal data assistants (PDAs), etc.

Accordingly, the present invention also resides in an image display device comprising the aforementioned optical film provided on the image display surface of its image display panel. Furthermore, an image display device according to the present invention may be advantageously realized in various forms, and preferably has an input/output device such as a touch panel on its image display panel and has an optical film according to the present invention on the input/output device. As a matter of course, image display devices according to the present invention do not exclude image display devices, having no input/output device such as a touch panel, such as portable TVs, display instruments, portable game machines, and car navigation systems.

FIG. 7 is a perspective view of a PDA that includes a typical image display device according to the present invention. The construction of it can be understood from FIG. 8, which is a cross-sectional view taken along line VIII-VIII of FIG. 7. The PDA 30 is so constructed that a liquid crystal display device 35 is accommodated in a casing 36, a touch panel 31 is disposed on the image display surface of the liquid crystal device 35, and an optical film 41 according to the present invention is adhered on the touch panel 31. Note that FIG. 7 shows a state that the optical film 41 is being adhered on the touch panel 31.

In the illustrated PDA 30, the optical film 41 has the structure as explained with reference to FIGS. 5 and 6. The optical film 41 includes a MELINEX™ film, which is an optically transparent polyester (PET) film, having the thickness of 50 μm, on the surface of which microstructures (quadrangular truncated pyramid microstructures) (not shown) are formed. Further, on a back surface of the optical film 41 used herein, a PET release liner having the thickness of 35.5 μm has been adhered through an acrylic adhesive layer having the thickness of 25 μm, as described with reference to FIG. 5, before the optical film 41 is adhered on the touch panel 31. In the practice of the present invention, the thickness of the optical film 41 and others should not be restricted to the above example. For example, generally, the thickness of the optical film is in the range of about 10 to 100 μm, the thickness of the acrylic adhesive layer is in the thickness of about 5 to 50 μm, and the thickness of the PET release liner is in the range of about 20 to 200 μm.

In the illustrated PDA 30, the optical film 41 can be easily adhered on the touch panel 31. For example, when a plastic card or the like is used as an applicator, troubles such as air entrainment (capture of bubbles) do not occur. An acrylic adhesive to be used has adhesive power of a controlled level so that the optical film does not peel off spontaneously, and may be removed without leaving behind any substantial paste material when the optical film is renewed. Furthermore, a thin hard coat layer may be applied on the optical film so that resistance to scratching is increased for a certain period.

The optical film 41 may temporarily protect the image display portion of the PDA. When the optical film has been worn out due to dust accumulation and/or scratching, it can be replaced with new one. However, the optical film does not peel off while it is used, and the user of the PDA can have confidence in it.

Furthermore, the optical film 41 is capable of protecting the screen of the PDA from dust and dirt in air in addition to scratching, and when an input operation to the touch panel is performed with a stylus pen 37, the pen does not slide on the touch panel, and the input operation can be continued easily with stability and excellent quality of writing. That is, the optical film according to the present invention has surface roughness to a certain extent because of the microstructures on the surface of it, thereby having a tactile property much like paper. However, the microreplicated pattern used is desirably tailored such that the transmission, haze and clarity of the protective film and display are not substantially compromised, and the sensitivity of the sensors detecting the stylus pen writing on the screen is not substantially reduced.

Furthermore, since the optical film 41 has microstructures formed in a regular pattern on its surface, the reflection of light can be effectively controlled by optimizing the pattern in dimension and distribution density, and thereby the glare of the screen or the like can be reduced.

An optical film according to the present invention may be advantageously manufactured by various methods. A particularly advantageous manufacturing method is a transfer method. The transfer method may be implemented in various manners. A long size optical film may be continuously made and cut into individual optical films at a downstream process, or optical films may be made one by one or in a few batches.

Furthermore, the transfer method may be implemented by using an embossing technique, or in a manner that curable or settable molding material is charged in a mold and then hardened. The mold includes a metallic mold, sheet-like mold, or the like.

A preferred embodiment of the present invention is a method of manufacturing an optical film comprising a transparent sheet-like substrate and a transparent reflecting layer formed on one side of the substrate, which includes, after forming the sheet-like substrate, the step of forming a reflecting layer, on one side of the substrate by transfer, having a plurality of surface reflection distribution areas each containing at least one microstructure.

A method of manufacturing an optical film according to the present invention in a transfer manner may be implemented preferably according to the following steps.

Mold Making Step:

Making a mold comprising a support and a shaping layer (hereinafter also referred to “form adding layer”) which is provided on the support and has a pattern of microstructure duplicating grooves, on the surface thereof, having a form, height, and distribution density corresponding to the micro structures of the surface reflection distribution areas.

Molding Material Charging Step:

Disposing curable or settable molding material between the sheet-like substrate and the shaping layer and charging the molding material in the microstructure duplicating grooves.

Optical Film Making Step:

Hardening the molding material to form an optical film comprising the sheet-like substrate and a reflecting layer on the surface of which microstructures integrally coupled with the sheet-like substrate are provided.

Optical Film Removing Step:

Removing the optical film from the mold.

The sheet-like substrate may be continuously supplied from a roll of substrate or may be supplied one by one.

The optical film may be made by a batch system, or in a manner that a large optical seat consisting of many optical films is made and then cut into individual optical films.

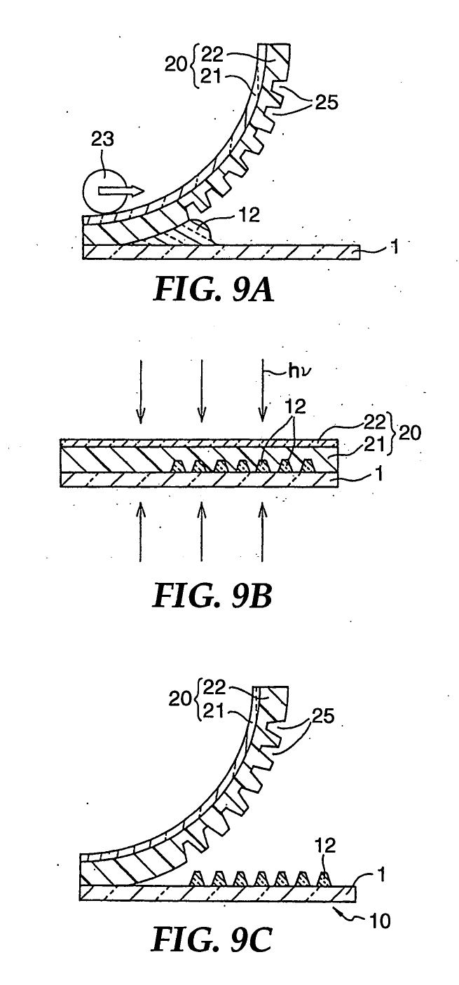

More specifically, the optical film manufacturing method described above may be advantageously implemented step by step as shown in FIG. 9.

At first, a mold 20 as shown in FIG. 9(A) is prepared. The mold 20 comprises a support 21 and a shaping layer 22 which is provided on the support 21 and has a pattern of microstructure duplicating grooves 25, on the surface thereof, having a form, height, and distribution density corresponding to the micro structures of the surface reflection distribution areas. The mold 20 may be made, for example, according to the steps of:

adhering an photo-curable resin material to a metallic mold (a replica of a target optical film), which has a pattern of protrusions having a form and dimensions corresponding to the pattern of grooves of the mold 20, to form an photo-curable resin material layer;

attaching a transparent support consisting of a plastic film onto the metallic mold to form a laminated article consisting of the metallic mold, the photo-curable resin material layer, and the support;

applying light to the laminated article from the support side of it to cure the photo-curable resin material layer; and

removing the shaping layer formed by curing the photo-curable resin material layer, together with the support from the metallic mold.

A transparent sheet-like substrate 1 is set on a platen (not shown) and then the flexible mold 20 is disposed in a predetermined position on the substrate 1, and alignment between the substrate 1 and mold 20 is performed.

Next, a laminating roll 23 is placed on one end portion of the mold 20. The laminating roll 23 is preferably a rubber roll.

At that time, the end portion of the mold 20 is preferably fixed on the substrate 1, because the displacement between the substrate 1 and mold 20 on which alignment has been completed can be prevented.

Next, the free end portion of the mold 20 is moved upward to the laminating roll 23 while being lifted with a holder (not shown) to expose the substrate 1. At this time, tension on the mold 20 is prevented so that the mold 20 is prevented from wrinkling and the alignment on the mold 20 and substrate 1 is maintained.

Thereafter, predetermined amount of plastic material (photo-curable resin) necessary for making a reflecting layer is supplied onto the substrate 1. For the supply of the plastic material, a paste hopper with a nozzle, for example, may be used.

In the practice of the illustrated manufacturing method, the plastic material 12 is not supplied evenly onto the whole of the substrate 1. The plastic material 12 may be supplied only to the portion, as shown in FIG. 9(A), near the laminating roll 23, on the substrate 1, because the plastic material 12 can be spread evenly on the substrate 1 when the laminating roll 23 moves on the mold 10 at a step described later. In such a case, the viscosity of the plastic material is preferably adjusted so as to be suitable for such spreading. The viscosity of the plastic material is normally about 20,000 cps or less. Furthermore, a method for supplying the plastic material is not limited to the methods described. For example, the plastic material may be coated on the whole surface of the substrate, which is not shown.

Next, the rotating motor (not shown) is driven to move the laminating roll 23 on the mold 20, as indicated by an arrow in FIG. 9(A), at a predetermined speed. While the laminating roll 23 is being moved like this, pressure is applied to the mold by the weight of the laminating roll 23 in succession from one end of it to the other end, the plastic material is spread between the substrate 1 and the mold 20, and the plastic material 12 is charged in the grooves 25 of the mold 20.

Furthermore, in the manufacturing method shown, the grooves of the mold serve as channels for air so that air captured in the grooves is discharged to the outside or around of the mold effectively by the above applied pressure. As a result, in this manufacturing method, even if the plastic material is charged in the grooves under atmospheric pressure, bubbles remaining in the grooves can be prevented.

Next, the plastic material is hardened. In this step, since photo-curable resin is used as a reflecting layer-forming material, the laminated article consisting of the substrate 1 and the mold 10 is put into a photo-irradiation device (not shown), and then light such as ultraviolet light (UV) is applied to the plastic material 12 through the substrate 1 and the mold 20 to cure it. Thus, the microstructures 12 made of photo-curable resin are obtained. Lastly, while the obtained microstructures 12 are held adhered on the substrate 1, the substrate 1 and the mold 20 are taken out of the photo-irradiation device, and then the mold 20 is peeled off as shown in FIG. 9(C). The obtained optical film 10 is shown, for the sake of simplicity, in a state that the microstructures 12 are integrally adhered to the sheet-like substrate 1, although the optical film 10 comprises, as a matter of fact, a reflecting layer made of material identical to that of the microstructures 12. Furthermore, in the method shown, optical films 10 are made by a batch system, although they can be continuously made of a sheet-like substrate 1 supplied from a roll or by other method.

Optical films having microstructures on the surface of them may be advantageously formed also by using a flame embossing technique. The flame embossing technique is known as a microreplication technique in which a sheet-like substrate consisting of, for example, a PET film is contacted to a heating roll having a pattern of grooves corresponding to the microstructures to soften the sheet-like substrate and emboss a pattern of the microstructures on the surface of it, by which an optical film is completed.

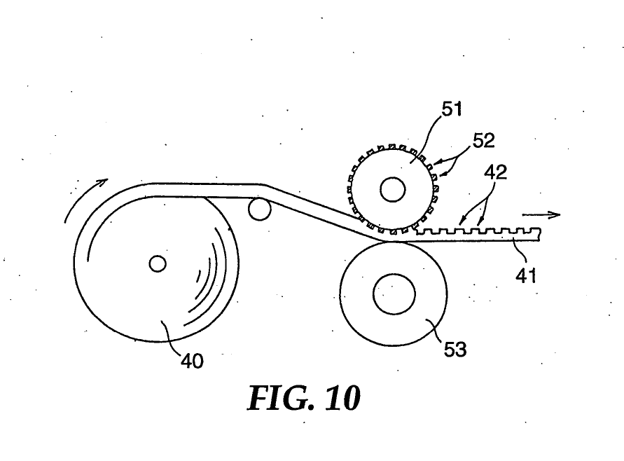

FIG. 10 schematically shows a method of continuously making optical films 41 shown in FIG. 6 by using a flame embossing technique. The optical films 41 may be made in a manner that a sheet-like substrate film sent from a roll 40 of sheet-like substrate (e.g., PET film) is guided between a heated embossing roller 51 and a pressing rubber roller 53 at a predetermined speed. The embossing roller 51 is made of steel and has a pattern of grooves 52 corresponding to a pattern of microstructures 42 to be added on the surface of an optical film 41. When the PET film passes through between a pair of rollers, it is softened, and the pattern of microstructures 42 is transferred to the surface of it.

### EXAMPLES

The present invention is described below with reference to its examples. It should be noted that the present invention is not limited to these examples.

### Example 1

In this example, an optical film as described with reference to FIGS. 1 and 2 was made.

100 wt. pts. of aliphatic urethan acrylate oligomer (trade name “Ebecry1270” of Daicel UBC Co., Ltd), 25 wt. pts. of phenoxy ethyl acrylate (trade name “Light Acrylate PO-A of Kyoeisha Chemical Co., Ltd.), and 1.25 wt. pts. of 2-hydroxy-2-methyl-1-phenyl-propane-1-on (photo-polymerization initiator, trade name “Darocure1173” of Ciba Specialty Chemicals) were mixed to prepare microstructure forming UV-curable resin.

A sheet-like mold made of polypropylene resin was prepared, the surface of which was engraved with a pattern of grooves corresponding to target prismatic microstructures.

Next, necessary amount of UV-curable resin made at the previous step was coated on the prepared mold and charged in the grooves. Then, the mold was overlaid with a polyester (PET) film for a substrate. The PET film used at this step was PET film (trade name “HPE188” of Teijin) having the thickness of 100 μm.

Next, in the state that UV-curable resin was charged in the concavities of the mold, light with the wavelength of 300 to 400 nm was applied to the UV-curable resin for 30 seconds through the PET film by using a fluorescent lamp of Mitsubishi Electric Osram Ltd. The UV-curable resin was cured and a reflecting layer was obtained. Next, the PET film was peeled off together with the reflecting layer from the mold, and a target optical film as shown in FIGS. 1 and 2 was obtained. In the obtained optical film, the thickness of the reflecting layer was about 300 μm. The prismatic microstructures (quadrangular pyramid microstructures) formed on the surface of the reflecting layer had the pitch (p) of 110 μm, and the height of 63 μm.

### Example 2

In this example, the reflecting layer of the optical film of Example 1 was laminated with a protective coating. A fluorine silane coupling agent (trade name “Optool DSX”; Daikin) containing perfluoropolyether groups and alkoxy silane groups as given by the following formula was prepared as material of a protective coating.
F—(CF₂CF₂CF₂O)ₙ—Si(OMe)₃: 80 mol %
F—(CF₂CF₂CF₂O)ₙ—CF₂CF₃: 20 mol %
Me=methyl group

20 wt. pts. of silane coupling agent was diluted with 80 wt. pts. of hydrofluoro ether (trade name “HFE-7100” of 3M), which was a fluorine agent, to prepare coating solution. Next, the optical film of Example 1 was steeped in the obtained coating solution to form a protecting coating made of a silane coupling agent on the reflecting layer side of the optical film. The thickness of the protective coating was about 0.1 μm, and the prismatic microstructures on the reflecting layer were totally covered with the protecting coating.

### Example 3

### Evaluation Test

In this example, characteristics of the optical film of Example 2 were evaluated in terms of (1) visibility, (2) degree of reflection, and (3) degree of easiness of wiping off a fingerprint. Furthermore, for the comparison with the optical film, a commercially available matted polyester (PET) film (125 μm thickness, trade name “Tetron™” of Teijin) was prepared.

(1) Visibility Test

After an optical film (inventive film) and a PET film (reference film) had been adhered on the image display surface of a commercially available PDA, the respective surfaces of the films were rubbed repeatedly with a finger so that fingerprint (sebum) stains were put on the surfaces.

Next, the PDA was powered on, and then the visibility during image display was evaluated qualitatively. In case of the inventive film, light incident on the surface of the inventive film was reflected in various directions by the surfaces of some prismatic microstructures, and thereby stains such as fingerprints added on the surface of the inventive film became hard to be visible. That is, in case of the inventive film, existence of the prismatic microstructures could suppress the reduction of display performance caused by the stains, thereby improving the visibility. On the other hand, in case of the reference film, the stains such as fingerprints were conspicuous, which caused discomfort.

(2) Reflection Test

As in the case of the visibility test, an optical film (inventive film) and a PET film (reference film) were adhered on the image display surface of a commercially available PDA.

Next, the PDA was placed directly below the fluorescent light in the room at the distance of about 2 m from the light, and the degree of reflection of the fluorescent light into the optical film was observed with the naked eye from a slanting direction. In case of the inventive film, light incident on the surface of the optical film was reflected in various directions by the surfaces of the prismatic microstructures, and thereby reflection of the fluorescent light into the inventive film could be prevented. That is, in case of the inventive film, the existence of the prismatic microstructures could prevent reductions in visibility due to the reflection of objects around the film into it. On the other hand, in case of the reference film, the reflection of the fluorescent light into the film was distinctly observed.

(3) Test of Degree of Easiness of Wiping off a Fingerprint

As in the case of the visibility test, an optical film (inventive film) and a PET film (reference film) were adhered on the image display surface of a commercially available PDA. In this test, an inventive film without a protective film of Example 1 and a reference film on which a protective coating having the thickness of about 0.1 μm had been formed according to the procedure of embodiment 2 were also adhered on the PDA.

Next, the respective surfaces of the four kinds of sample films in total adhered on the PDA were rubbed repeatedly with a finger so that fingerprint (sebum) stains were put on the surfaces. The respective fingerprint stains were wiped off with a towel, and the degree of easiness of wiping off a fingerprint was evaluated qualitatively. It was commonly observed on the inventive film and reference film with a protective coating made of silane coupling agent that fingerprint stains could be wiped off well.

Next, in order to numerically evaluate the easiness of wiping off a fingerprint, the respective surface energies of the sample films were measured in terms of contact angles. The contact angles (degree) were measured with a contact angle meter (trade name “CONTACT ANGLE METER” of Kyowa Kaimen Kagaku) using water of 0.05 μl based on a method required by JIS-R-3257. The following result of the measurement was obtained.

| | without | with |
|---|---|---|
| Sample Film | Protective Film | Protective Film |
| Optical Film | 105.4° | 124.6° |
| (Inventive Film) | | |
| PET Film | 70.4° | 112.4° |
| (Reference film) | | |

As understood from the above result of the measurement, in case that an optical film according to the present invention has a protective coating, the water repellency and oil repellency were improved, and stains such as fingerprints could be effectively removed.

As described above in detail, the present invention provides an optical film improved in visibility without the adhesion of a fingerprint and the deterioration of the contrast. This optical film is capable of resisting a scratch or the like and preventing the adhesive of dust or the like, and even if dust or the like has adhered to this optical film, the dust or the like can be removed easily. Since an optical film according to the present invention has such characteristics, it may be advantageously used for various image display devices, and in particular may be more advantageously used for input/output devices such as touch panels and graphic panels, being adhered on them.

Furthermore, the present invention provides a method of manufacturing an optical film according to the present invention easily with high accuracy.

Furthermore, the present invention provides an image display device taking advantages of the excellent characteristics of an optical film according to the present invention.

What is claimed is:

1. An optical film comprising a transparent reflecting film on the surface of which a plurality of surface reflection distribution areas each containing at least one microstructure are provided.

2. The optical film according to claim 1 comprising a transparent sheet-like substrate and a transparent reflecting layer formed on one side of said substrate, wherein said transparent reflecting layer is said reflecting film on the surface of which a plurality of surface reflection distribution areas are provided.

3. The optical film according to claim 1, wherein said microstructures are prismatic microstructures.

4. The optical film according to claim 1, wherein said microstructures are disposed on said reflecting film in a regular pattern, have a predetermined shape and height, and are distributed in a predetermined density.

5. The optical film according to claim 1, wherein said reflecting film is made of a plastic material.

6. The optical film according to claim 1, wherein a protecting coating is formed on said reflecting film

7. The optical film according to claim 1 adhered on the image display surface of an image display device in a manner that the reflecting film side of said optical film is exposed.

8. The optical film according to claim 7 through which direct input to the input/output device of said image display device is possible when the reflecting film side of said optical film is touched with a pen or finger.

9. A method of producing an optical film comprising the step of making a reflecting film by adding a plurality of surface reflection distribution areas each containing at least one microstructure to one side of a transparent film by transfer.

10. The method according to claim 9, wherein said reflecting film is made in the form of a transparent reflecting layer supported by a transparent sheet-like substrate.

11. The method according to claim 9, wherein transfer of said surface reflection distribution areas is performed by using an embossing technique.

12. The method according to claim 9, wherein transfer of said surface reflection distribution areas is performed by charging curable or settable molding material in a mold and hardening said curable or settable molding material.

13. The method according to claim 10 comprising steps of:
preparing a mold comprising a support and a shaping layer which is provided on said support and has a pattern of microstructure duplicating grooves, on the surface thereof, having a form, height, and distribution density corresponding to said micro structures of said surface reflection distribution areas;
disposing curable or settable molding material between a sheet-like substrate and said shaping layer to charge said molding material in said microstructure duplicating grooves;
hardening said molding material to form an optical film comprising said sheet-like substrate and a reflecting layer on the surface of which microstructures integrally coupled with said sheet-like substrate are provided; and
removing said optical film from said mold.

14. An image display device comprising an optical film according to claim 1 provided on an image display surface of the image display panel thereof.

15. The image display device according to claim 14, wherein said image display panel further comprises a touch panel under said optical film.
